(19) United States
(12) Patent Application Publication
(10) Pub. No.: US 2026/0158883 A1
(43) Pub. Date: Jun. 11, 2026

(54) COLLAPSIBLE ENTRANCE DOOR

(71) Applicant: Lightship Energy, Inc., Broomfield, CO (US)

(72) Inventors: Robert JONES, Broomfield, CO (US); Calvin CHANG, Broomfield, CO (US); Pavel YAKOVLEV, Broomfield, CO (US); Barrie DICKINSON, Broomfield, CO (US)

(73) Assignee: Lightship Energy, Inc., Broomfield, CO (US)

(21) Appl. No.: 19/414,851

(22) Filed: Dec. 10, 2025

Related U.S. Application Data
(60) Provisional application No. 63/730,323, filed on Dec. 10, 2024.

(51) Int. Cl. B60J 5/04; B60J 5/06; B62D 63/06; E05B 83/44; E05D 7/081

(52) U.S. Cl. CPC B60J 5/0486; B60J 5/062; E05B 83/44; E05D 7/081; B62D 63/061

(57) ABSTRACT

An apparatus includes a first portion of a collapsible door and a second portion of the collapsible door. The second portion of the collapsible door is slidably coupled to the first portion such that the first portion is configured to slide vertically relative to the second portion to move the collapsible door between a collapsed configuration and an expanded configuration. The first portion and the second portion collectively are configured to pivot about a single hinge axis to move the collapsible door between an open position and a closed position in both the collapsed configuration and the expanded configuration.

### CROSS-REFERENCE TO RELATED APPLICATIONS

This application claims priority to and the benefit of U.S. Provisional Application No. 63/730,323, filed Dec. 10, 2024, entitled, “Collapsible Entrance Door,” the disclosure of which is incorporated herein by reference in its entirety.

### BACKGROUND

The present application relates generally to collapsible entrance doors and more particularly, to collapsible entrance doors for collapsible trailers.

Certain vehicles, such as trailers, recreational vehicles, etc., are able to transition between a collapsed mode and an expanded mode. The collapsed mode can be a mode that allows for the collapsible vehicle to be towed in a more aerodynamic configuration to reduce the drag and thus the energy consumption. The expanded mode can be a mode that allows for the inside of the vehicle to be comfortably entered and used by a user and can be used at a campsite, a parking lot, or similar area.

It is desirable for the inside portion of the vehicle to be accessible both in the collapsed mode and the expanded mode. Generally, two-part doors are used that are separately coupled to a top portion and a bottom portion of the trailer. Often, the two parts of the door are separately hinged and require manual intervention to configure into a state where the two parts of the door can be opened together as one door. The manual intervention can be inconvenient for a user, and the mechanism is often bulky and results in unusable space in the entryway. Thus, there is a need for a door that can transition between a collapsed mode and an expanded mode that has portions that are opened and closed together without user intervention.

### SUMMARY

In some embodiments, an apparatus includes a first portion of a collapsible door and a second portion of the collapsible door. The second portion of the collapsible door is slidably coupled to the first portion such that the first portion is configured to slide vertically relative to the second portion to move the collapsible door between a collapsed configuration and an expanded configuration. The first portion and the second portion collectively are configured to pivot about a single hinge axis to move the collapsible door between an open position and a closed position in both the collapsed configuration and the expanded configuration.

In some embodiments, an apparatus includes a first portion of a collapsible door and a second portion of the collapsible door. The second portion of the collapsible door is slidably coupled to the first portion such that the first portion is configured to slide relative to the second portion to move the collapsible door between a collapsed configuration and an expanded configuration. The apparatus further includes a first hinge coupled to the first portion of the collapsible door, and a second hinge coupled to the second portion of the collapsible door. The first hinge and the second hinge collectively define a single hinge axis. The collapsible door is rotatable about the single hinge axis between an open position and a closed position when in each of the collapsed configuration and the expanded configuration.

In some embodiments, an apparatus includes a first portion of a collapsible door and a second portion of the collapsible door. The second portion of the collapsible door is slidably coupled to the first portion to allow the collapsible door to be transitioned between a collapsed configuration and an expanded configuration. The apparatus further includes a handle coupled to the first portion and configured to be actuated to release the door latch and allow movement of the collapsible door about a single hinge axis between an open position and a closed position when the collapsible door is in the collapsed configuration and the expanded configuration. In some embodiments, the handle is a first handle that is coupled to an outer surface of the first portion, and the apparatus further includes a second handle coupled to an inner surface of the first portion and a third handle coupled to the inner surface of the first portion. In such embodiments, the second handle is configured to be actuated to release the door latch and allow movement of the collapsible door between the open position and the closed position when the collapsible door is in the expanded configuration and the second handle is configured to be actuated to release the door latch and allow movement of the collapsible door between the open position and the closed position when the collapsible door is in the collapsed configuration.

### BRIEF DESCRIPTION OF THE DRAWINGS

Reference should be made to the following detailed description which should be read in conjunction with the following figures, wherein like numerals represent like parts.

FIG. 1 is a schematic block diagram of a trailer system including a collapsible door, according to an embodiment.

FIGS. 2A-2B depict perspective views of a collapsible door in a collapsed configuration, according to an embodiment.

FIGS. 2C-2D depict perspective views of the collapsible door of FIGS. 2A-2B in an expanded configuration.

FIGS. 3A-3B depicts perspective views of a collapsible door, according to an embodiment.

FIGS. 4A-4C depict detailed views of the hinges of a collapsible door, according to embodiments.

FIGS. 5A-5B depict detailed views of a slider of a collapsible door, according to an embodiment.

FIGS. 6A-6B depict perspective views of a latch of a collapsible door, according to an embodiment.

FIGS. 7A-7B depict perspective views of a collapsible door, according to an embodiment.

FIGS. 8A-8C depict various views of a bottom hinge of the collapsible door shown in FIGS. 7A-7B.

### DETAILED DESCRIPTION

The present disclosure is not limited in its application to the details of construction and the arrangement of components set forth in the following description or illustrated in the drawings. The examples described herein may be capable of other embodiments and/or of being practiced or performed in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Some embodiments herein relate to collapsible doors (e.g., entrance doors) of a vehicle (e.g., collapsible trailer, trailer, recreational vehicle, collapsible vehicle, etc.) that are configured to allow for access into the vehicle in both a collapsed configuration (e.g., collapsed mode, etc.) and an expanded configuration (e.g., expanded mode). The collapsible door includes a first portion and a second portion that are configured to slide vertically relative to each other and to be coupled together via a slider such that the two portions move together when the collapsible door is opened and closed. The collapsible door is also configured to be hingedly coupled to a body of the vehicle such that the door and the hinges are substantially flush against the body of the vehicle to reduce drag on the vehicle during motion. The collapsible door includes a latch that can be operated by one or more handles that can be accessed in both the collapsed configuration and the expanded configuration.

The collapsible door described herein can be used on a wide range of vehicles or other collapsible structures, including recreational vehicles, trailers, and any vehicle configured to be collapsed from an expanded configuration. During use, the collapsible door is configured to provide a consistent experience to a user so that the user can access an inner space of the vehicle by operating one handle of the collapsible door to open and/or close the entire door. By integrating the two portions, the collapsible door can further allow for a wider entryway than known two-part doors. In some embodiments, the collapsible door can allow for a standard wheelchair to access the doorway.

In some embodiments, the collapsible door can be configured to be actuated (e.g., to open and close the collapsible door) in the same manner when the collapsible door is in both the collapsed configuration and the expanded configuration. In other words, the user does not have to use different manipulations to operate the collapsible door when the collapsible door is in different configurations, thereby providing a consistent user experience. In some embodiments, the collapsible door can include a handle configured to be actuated to move the collapsible door between an open position and a closed position in both the collapsed configuration and the expanded configuration. In some embodiments, the collapsible door can be configured to rotate about a single hinge axis in both the collapse configuration and the expanded configuration to open and close the door. For example, the door can be coupled to the trailer via a hinge that rotates the collapsible door about the same hinge axis when the collapsible door is in both the collapsed configuration and the expanded configuration. Therefore, the collapsible door moves through a single range of motion when moving between the open position and the closed position in both the expanded configuration and the collapsed configuration, making the collapsible door easier to operate than two-part doors that require more complex manipulations.

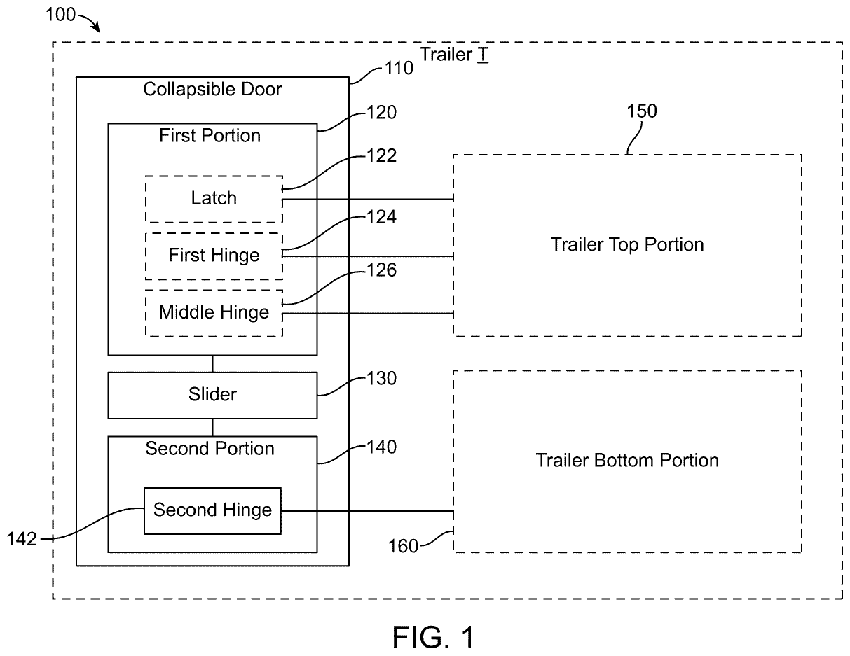

FIG. 1 is a schematic block diagram of a trailer system 100 including a collapsible door 110. The trailer system 100 includes a trailer T that is configured to operate between a collapsed configuration and an expanded configuration. The trailer T includes a trailer top portion 150 (e.g., canopy) and a trailer bottom portion 160 (e.g., tub). In the collapsed configuration, the trailer top portion 150 (also referred to herein as the “upper portion”) and the trailer bottom portion 160 are configured to nest together such that at least a portion of the trailer top portion 150 and the trailer bottom portion 160 are overlapping. In some embodiments, the trailer top portion 150 is configured to nest within the trailer bottom portion 160. In some embodiments, the trailer bottom portion 160 is configured to nest within the trailer top portion 150.

The collapsible door 110 is coupled (e.g., fixedly, selectively, etc.) to the trailer T such that the collapsible door 110 moves between a collapsed configuration and an expanded configuration together with the trailer top portion 150 and the trailer bottom portion 160. The collapsible door 110 is further configured to operate between a closed position (e.g., closed configuration, closed mode, etc.) and an open position (e.g., open configuration, open mode, etc.). In the closed position, the collapsible door 110 is configured to prevent access into an interior of the trailer T. In the open position, the collapsible door 110 is configured to allow access into the interior of the trailer T. The collapsible door 110 can be a right-handed door or a left-handed door. The collapsible door 110 can include a first portion 120 and a second portion 140. In some embodiments, the collapsible door can include a slider 130 (e.g., a transitioning mechanism) configured to move one of the first portion 120 or the second portion 140 relative to the other of the first portion 120 or the second portion 140. The first portion 120 can include a latch 122 and one or more hinges (e.g., a first hinge 124 and/or a middle hinge 126). The second portion 140 can include a second hinge 142. For ease of description, the first hinge 124 is referred to herein as an upper hinge and the second hinge 142 as a bottom hinge. It should be understood, however, that these relative positional terms are for ease of description only and in other embodiments, the second hinge 142 can be located above the first hinge 124. In some embodiments, the latch 122 and/or the middle hinge 126 may be optional.

For ease of description, the first portion 120 of the collapsible door 110 can be referred to as a top portion or upper portion of the collapsible door 110 that is coupled to the trailer top portion 150 (or trailer upper portion) and the second portion 140 of the collapsible door 110 can be referred to as a bottom portion that is coupled to the trailer bottom portion 160. It should be understood, however, that these relative positional terms are for ease of description only and in other embodiments, the second portion 140 of the collapsible door 110 can be coupled to the trailer top portion 150 and the first portion 120 of the collapsible door 110 can be coupled to the trailer bottom portion 160.

During operation, the first portion 120 of the collapsible door 110 is configured to move vertically together with the trailer top portion 150 when the trailer T transitions between the expanded configuration and the collapsed configuration. In some embodiments, the first portion 120 includes a body that includes an inner surface (e.g., surface adjacent to the inside of the trailer T) and an outer surface, opposite the inner surface. In some embodiments, the body of the first portion 120 can include an opening, window, and/or the like to allow for light to enter the trailer T. In some embodiments, the first portion 120, when in a closed position, is configured to be seated flush against a recessed door jamb of the trailer top portion 150.

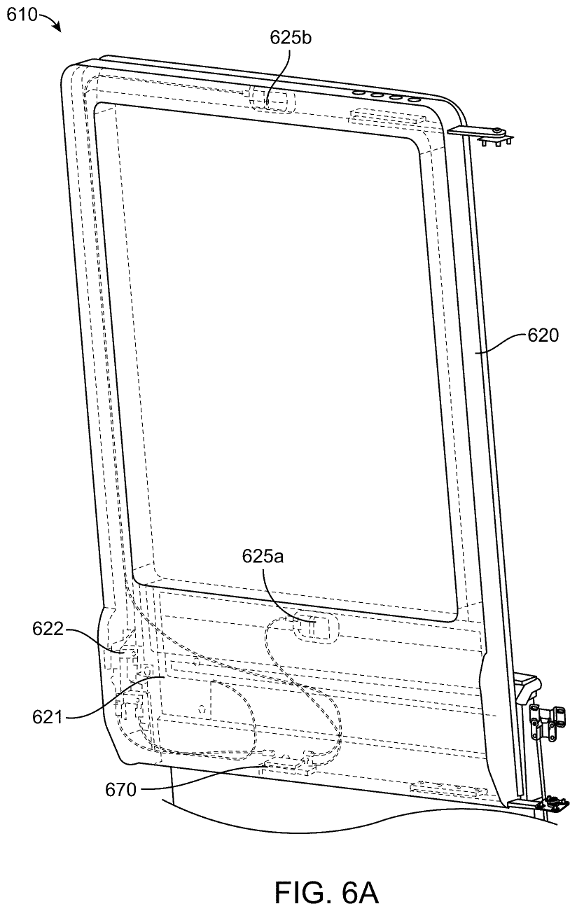

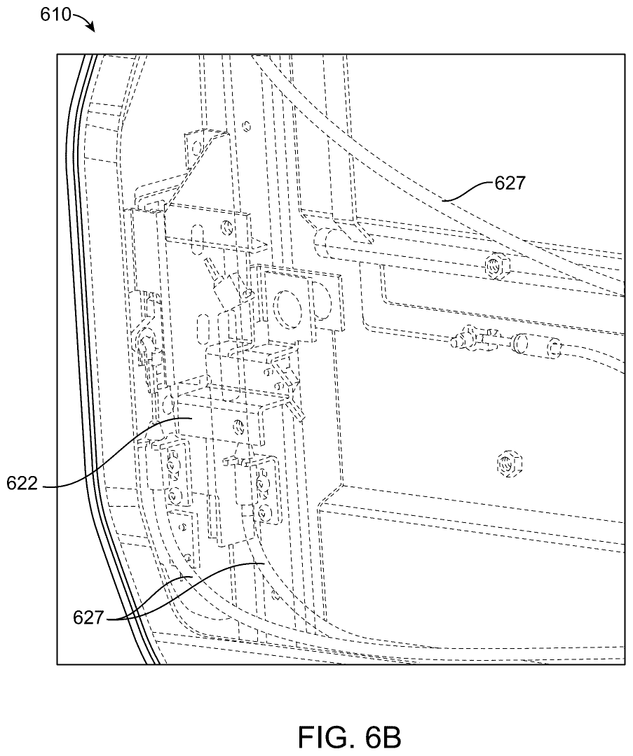

The latch 122 is configured to engage the trailer top portion 150 so that, when the latch 122 is engaged with the trailer top portion 150, the first portion 120 (and thus the collapsible door 110) is prevented from opening in the closed position. The latch 122 can be disengaged (e.g., unlocked) via one or more handles. For example, the handles can be included on an outside surface of the first portion 120 and/or on an inside surface of the first portion 120 such that the latch 122 can be unlocked for either inside the trailer T or from the outside. In some embodiments, the inside surface and/or the outer surface of the first portion 120 can include more than one handle located in different areas of the corresponding surfaces so that that at least one handle can be accessible to a user in both the collapsed configuration and the expanded configuration. In some embodiments, the handle can be actuated to release the door latch and allow movement of the collapsible door 110 between an open position and a closed position when the collapsible door 110 is in both the collapsed configuration. In some embodiments, the handle can be actuated in the same manner to release the door latch and allow movement of the collapsible door 110 in both the expanded configuration and the collapsed configuration. In some embodiments, the latch 122 can include a locking mechanism (e.g., electric lock, manual lock, etc.) that can prevent the latch 122 from being unlocked by the handles. In some embodiments, the latch 122 and/or one or more of the handles can be included in the second portion 140. In some embodiments, the latch 122 can be operatively coupled to a splitter coupled to the handles. In some embodiments, the latch 122 can include one or more switch configured to determine at least one of an open position of the latch 122, a closed position of the latch 122, a locked position of the collapsible door 110, or an unlocked position of the collapsible door 110. In some embodiments, the one or more switches can include a door handle limit switch, a reed switch, and/or the like. In some embodiments, the latch 122 can be adjustable. An embodiment of latch 122 is further described in reference to FIG. 6A-6B.

The first portion 120 is configured to couple to the trailer top portion 150 via the upper hinge 224 and/or the middle hinge 126 such that the first portion 120 can be hinged about a hinge axis between the open position and the closed position. The upper hinge 224 and the middle hinge 126 are configured to couple to the trailer top portion 150 at hinge points (e.g., pivot points, etc.) along the hinge axis about which the first portion 120 can rotate. In some embodiments, the first hinge 124 and/or the middle hinge 126 can include components that allow for the first portion 120 to be offset from the trailer top portion 150 when the collapsible door 110 is in the open position. In some embodiments, the first hinge 124 and/or the middle hinge 126 can be configured to be disposed in a corresponding slot in the trailer top portion 150 so that the first hinge 124 and/or the middle hinge 126 are flush with an outer surface of the trailer top portion 150 when the collapsible door 110 is in the closed position.

The first hinge 124 is positioned near the top of the first portion 120. The first hinge 124 is coupled to the trailer top portion 150. In some embodiments, the first hinge 124 is coupled to the trailer top portion 150 via one or more fastener (e.g., screw, bolt, etc.), a weld, an adhesive (e.g., glue, epoxy, etc.). In some embodiments, the hinge includes a hinging mechanism such as a bearing, a pivot hinge, a butt hinge, and/or the like that is configured to operate about a hinge axis. In some embodiments, the first hinge 124 includes an offset bar between the hinging mechanism and the body of the first portion 120. The offset bar can be configured to be fixedly coupled to the body of the first portion 120 to allow for spacing between the hinge point and the body of the first portion 120. The spacing allows for the first portion 120 to be hinged beyond the door jamb of the trailer top portion 150 so that the first portion 120 can be flush against the trailer top portion 150 when the collapsible door is in the closed position.

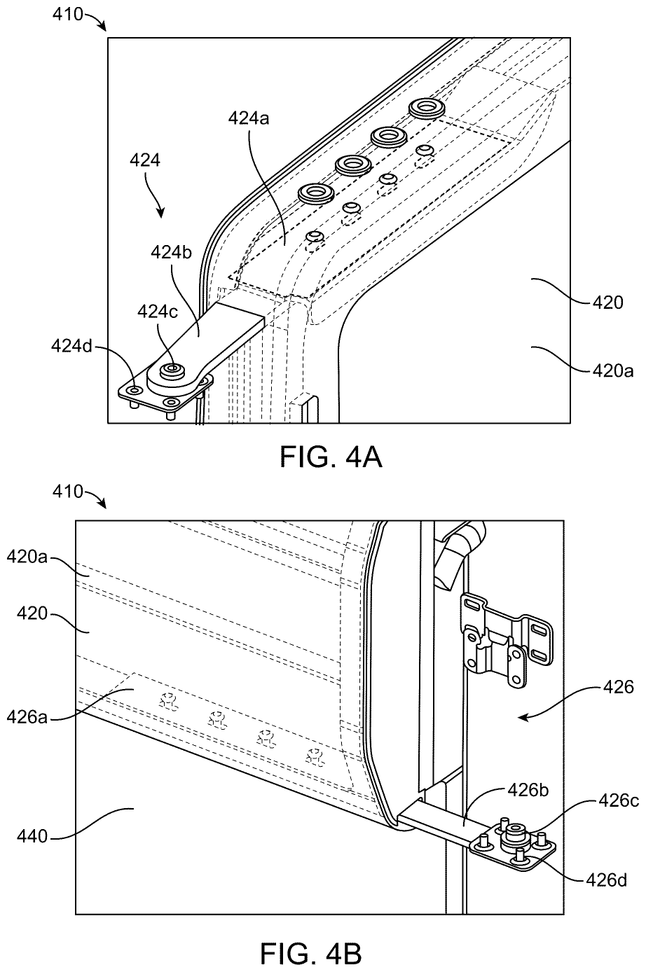

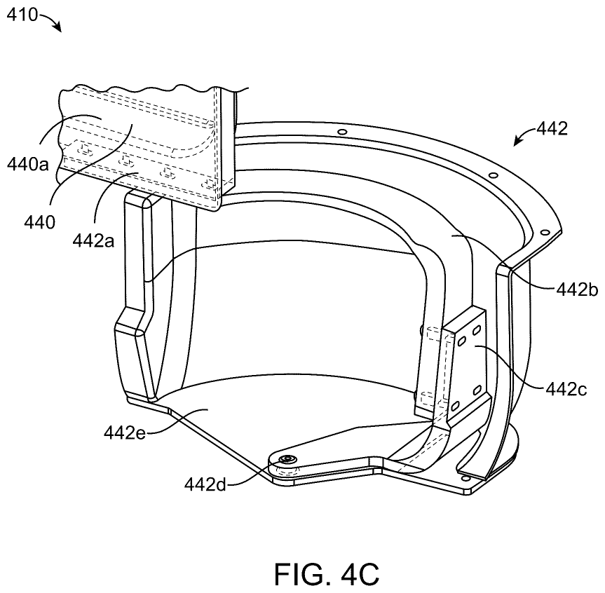

The middle hinge 126 is positioned near the bottom of the first portion 120, on the same side as the first hinge 124. In some embodiments, the middle hinge 126 is included in the second portion 140. The middle hinge 126 is coupled to the trailer top portion 150. In some embodiments, the middle hinge 126 is coupled to the trailer top portion 150 via one or more fastener (e.g., screw, bolt, etc.), a weld, an adhesive (e.g., glue, epoxy, etc.). In some embodiments, the middle hinge 126 includes a hinging mechanism such as a bearing, a pivot hinge, a butt hinge, and/or the like that is configured to operate above the hinge axis. In some embodiments, the middle hinge 126 includes an offset bar between the hinging mechanism and the body of the first portion 120. The offset bar can be configured to be fixedly coupled to the body of the first portion 120 to allow for spacing between the hinge point and the body of the first portion 120. The spacing allows for the first portion 120 to be hinged beyond the door jamb of the trailer top portion 150 so that the first portion 120 can be flush against the trailer top portion 150 when the collapsible door is in the closed position. Embodiment(s) of a first hinge 124 and a middle hinge 126 are further described in reference to FIGS. 4A-4B.

The second portion 140 is a portion (e.g., bottom portion) of the collapsible door 110 that is coupled to the trailer bottom portion 160. During operation, the second portion 140 is configured to be stationary together with trailer bottom portion 160 when the trailer T transitions between the expanded configuration and the collapsed configuration. In some embodiments, the second portion 140 includes a body that defines an inner surface (e.g., surface adjacent to the inside of the trailer T) and an outer surface, opposite the inner surface. In some embodiments, the second portion 140, when in a closed position, is configured to be seated flush against a recessed door jamb of the trailer bottom portion 160.

The second hinge 142 is positioned near the bottom of the second portion 140. The second hinge 142 is coupled to the trailer bottom portion 160. In some embodiments, the second hinge 142 is coupled to the trailer bottom portion 160 via one or more fasteners (e.g., screw, bolt, etc.), a weld, an adhesive (e.g., glue, epoxy, etc.). In some embodiments, the second hinge 142 includes a hinging mechanism such as a bearing, a pivot hinge, a butt hinge, and/or the like that is configured to operate about a hinge axis. In some embodiments, the hinge axis of the second hinge 142 is the same hinge axis of the first hinge 124 and/or the middle hinge 126.

In some embodiments, the hinging mechanism (e.g., one or more of the first hinge 124, the middle hinge 126, and/or the second hinge 142) can be configured to distribute the forces associated with the weight of the collapsible door 110. In some embodiments, the hinging mechanism can include one or more offset bar such that the hinge point is vertically and/or horizontally offset from the body of the second portion 140. In some embodiments, the second hinge 142 can be configured to allow for adjustment of the collapsible door 110 on the second hinge 142 in more than one dimension. In some embodiments, the second hinge 142 may be configured to be adjustable in three degrees of freedom. For example, the second hinge 142 can include a first offset bar and a second offset bar. The first offset bar can allow for adjustment in a first dimension. The second offset bar can couple to the first offset bar and further allow for adjustment in two additional dimensions. More specifically, the offset bar includes a first component extending away from the body of the second portion 140 and a second component hingedly coupled to the trailer bottom portion 160. The first component and the second component are fixedly coupled. An embodiment of a second hinge 142 is further described in reference to FIG. 4C. In some embodiments, the second portion 140 can include an additional hinge.

In some embodiments, the hinging mechanism can be configured such that the door hinges about the same hinge axis in the collapsed configuration and in the expanded configuration. For example, the first hinge 124, the middle hinge 126, and/or the second hinge 142 can define a single hinge axis (e.g., a vertical hinge axis), and the collapsible door 110 can be configured to move, pivot, rotate, etc. about this hinge axis in both the expanded configuration and the collapsed configuration. Therefore, the collapsible door 110 can be configured to allow the user to operate the door in the same manner or substantially the same manner (e.g., moves the door through the same range of motion) in the collapsed configuration and expanded configuration.

The slider 130 is configured to couple the first portion 120 and the second portion 140 such that the first portion 120 and the second portion 140 can slide between the open configuration and the closed configuration. The slider 130 is further configured to couple the first portion 120 and the second portion 140 together such that the first portion 120 and the second portion 140 move together between the open position and the closed position. The slider 130 is configured such that the first portion 120 and the second portion 140 are coupled to move together in both the collapsed configuration and the expanded configuration. The slider 130 allows for this tandem motion of the first portion 120 and the second portion 140 without user intervention to provide the user with a consistent experience.

In some embodiments, the slider 130 can include any type of mechanism that allows for the first portion 120 and the second portion 140 to slide vertically relative to one another (e.g., slidably coupled). For example, the slider 130 can include rails, slots, ball bearings, roller bearings, air bearings, gliders, linear bushings, channels, telescoping hinges, sliding tracks, and/or the like. In some embodiments, the slider 130 can include a first component included in or coupled with the first portion 120 and a corresponding component included in or coupled with the second portion 140. For example, the first portion 120 can include and/or be coupled to a rail and the second portion 140 can include and/or be coupled to a slider that is configured to be accepted by the rail. The slider can be an elongate shape that is configured to be accepted by the rail. The rail and slider then allow for the first portion 120 to vertically move relatively to the second portion 140 and vice versa. In some embodiments, the slider 130 is coupled to the first portion 120 and/or the second portion 140 via one or more fastener (e.g., bolt, screw, pin, latch, etc.). For example, the slider 130 can be coupled via a fastener that allows for adjustment of the slider 130 on the first portion 120 and/or the second portion 140.

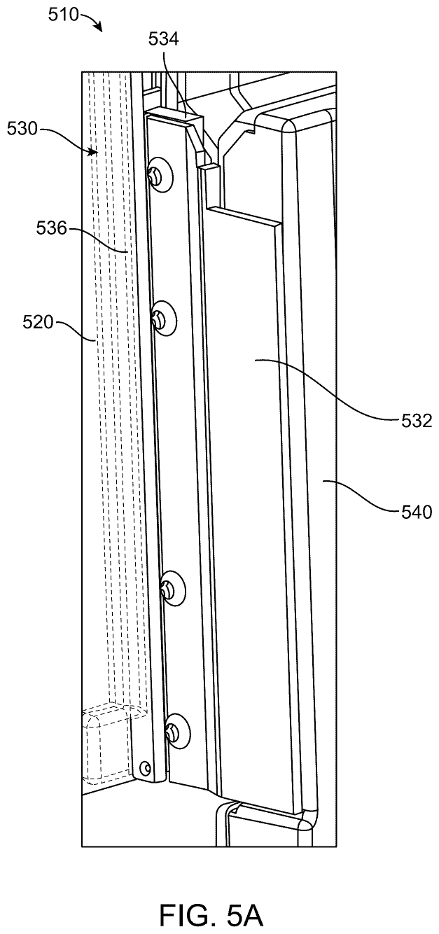

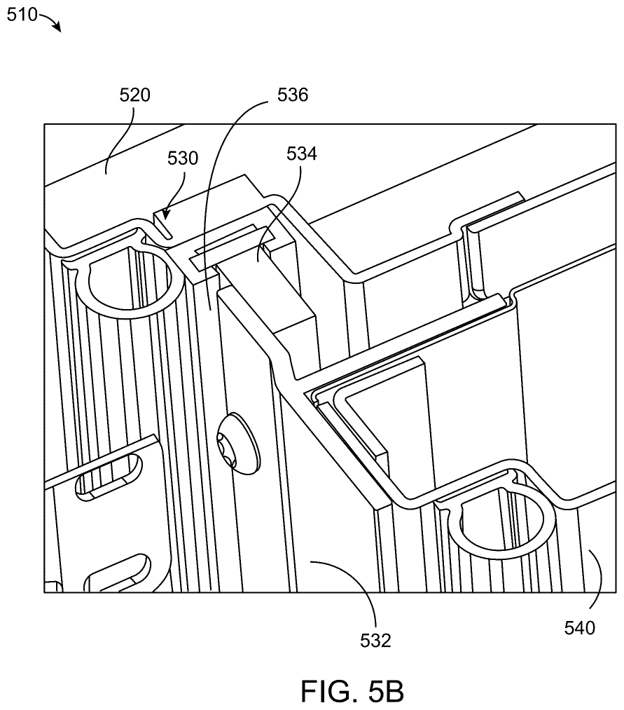

In some embodiments, the slider 130 can include more than one set of mechanisms. For example, the first portion 120 can include two rails on opposite sides of the body and the second portion can include two corresponding sliders. Including multiple rail/slider systems can increase the coupling strength between the first portion 120 and the second portion 140 and allow for smoother sliding. In some embodiments, the slider 130 can include a grease, lubrication, and/or the like that is configured to reduce the friction. In some embodiments, one or more portion of the slider 130 can be formed of a material that allows for reduced friction such as a nylon block, a composite, lubricated bearings or bushings, and/or the like. In some embodiments, during operation, the slider 130 allows for the first portion 120 to be on the outside of the second portion 140 in the collapsed configuration. In some embodiments, during operation, the slider 130 allows for the first portion 120 to be on the inside of the second portion 140 in the collapsed configuration. An embodiment of a slider 130 is further described in reference to FIGS. 5A-5B.

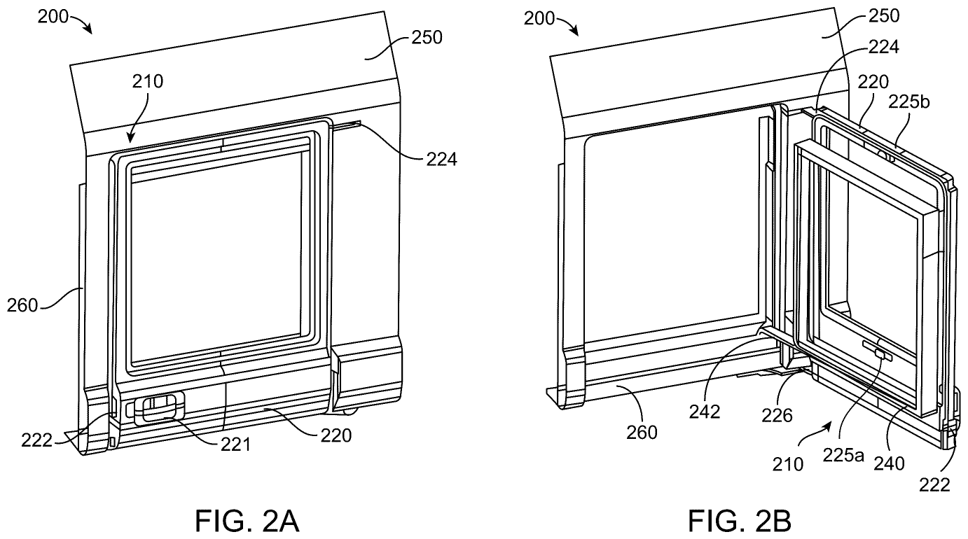

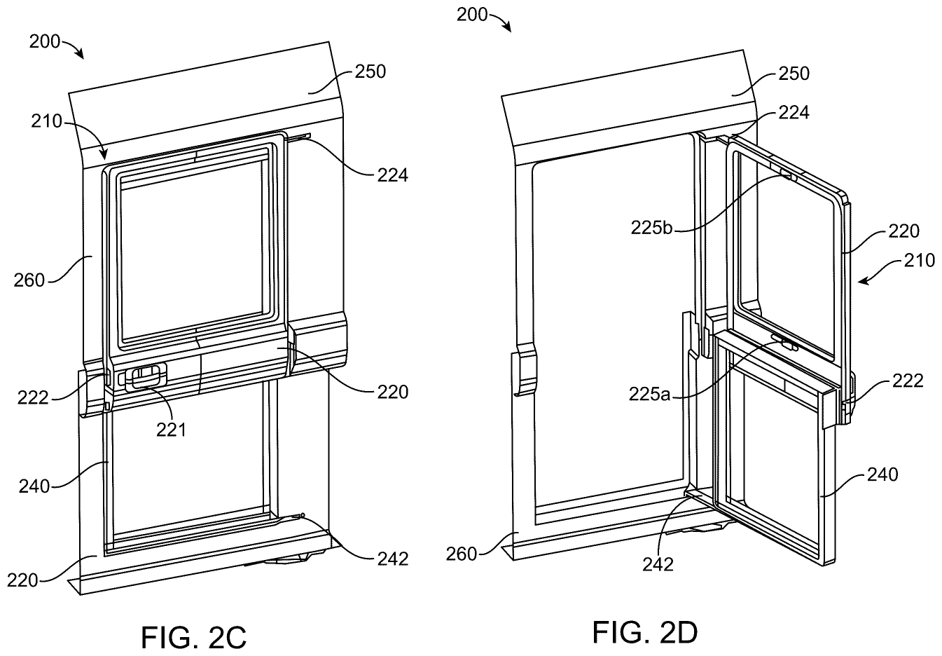

FIGS. 2A-2B depict perspective views of a collapsible door 210 of a trailer system 200 in a collapsed configuration, according to an embodiment. The collapsible door 210 and the trailer system 200 can be functionally and/or structurally similar to the collapsible door 110 and the trailer system 100, respectively. FIGS. 2C-2D depict perspective views of the collapsible door 210 in an expanded configuration. Referring generally to FIGS. 2A-2D, the trailer system 200 is configured to operate between the collapsed configuration as seen in FIGS. 2A-2B and the expanded configuration as seen in FIGS. 2C-2D. In both the collapsed configuration and the expanded configuration, the collapsible door 210 is configured to move between the closed position seen in FIGS. 2A and 2C and an open position seen in FIGS. 2B and 2D. While FIGS. 2A-2D depict a portion of the trailer system 200 (e.g., a portion around the collapsible door 210), the trailer system 200 can be implemented into a full trailer such as the trailer T described in FIG. 1.

As seen in FIG. 2A, the trailer system 200 includes a trailer top portion 250 and a trailer bottom portion 260 (e.g., functionally and/or structurally similar to the trailer top portion 150 and the trailer bottom portion 160, respectively, of FIG. 1) The trailer top portion 250, in the collapsed configuration, is configured to be on the outside of the trailer bottom portion 260. In some embodiments, the trailer top portion 250, in the collapsed configuration, may be configured to be on the inside of the trailer bottom portion 260. The trailer top portion 250 and the trailer bottom portion 260 are coupled to the collapsible door 210. The collapsible door 210 includes a first portion 220 and a second portion 240 (e.g., functionally and/or structurally similar to the first portion 120 and the second portion 140, respectively, of FIG. 1). The first portion 220 includes a latch 222, an outside handle 221, an upper hinge 224, and a middle hinge 226 (e.g., functionally and/or structurally similar to the latch 122, the first hinge 124, and the middle hinge 126, respectively, of FIG. 1). The second portion 240 includes a bottom hinge 242, a lower handle 225a, and an upper handle 225b. The bottom hinge 242 can be functionally and/or structurally similar to the second hinge 142.

The first portion 220 of the collapsible door 210 (e.g., an upper portion) is configured to abut an outer surface of the second portion 240 of the collapsible door 210 (e.g., a bottom portion) when the collapsible door is in the collapsed configuration. In the closed position, the first portion 220 is configured to be received by a recessed portion of a door jamb of the trailer top portion 250 and the second portion 240 is configured to be received by a recessed portion of a door jamb of the trailer bottom portion 260. In some embodiments, in the closed position, an outer surface of the first portion 220 and an outer surface of the trailer top portion 250 can be substantially flat as to reduce drag associated with air resistance when the trailer system 200 is in motion. The first portion 220 is coupled to the second portion 240 such that the first portion 220 and the second portion 240 move together between the closed position, as seen in FIGS. 2A and 2C, and the open position, as seen in FIGS. 2B and 2D. The first portion 220 and the second portion 240 are coupled together via a slider that allows for the first portion 220 and the second portion 240 to slide vertically relative to one another between the collapsed configuration, as seen in FIGS. 2A-2B, and the expanded configuration, as seen in FIGS. 2C-2D.

To allow for the first portion 220 and the second portion 240 to slide vertically relative to one another, the first portion 220 and the second portion 240 are coupled together via a slider (e.g., functionally and/or structurally similar to the slider 130 of FIG. 1). The slider is configured to allow for the collapsible door 210 to operate between the collapsed configuration and the expanded configuration both when the collapsible door 210 is in the open configuration and the closed configuration. For example, the slider allows for the collapsible door 210 to move between configurations when engaging the door jamb in the closed position or when the collapsible door 210 is cantilevered in the open position. The slider can include one or more sliding systems (e.g., rail/slider, etc.). In some embodiments, the slider can include two sliding systems on opposite ends (e.g., horizontal ends) of the collapsible door 210 to distribute forces associated with sliding and to increase rigidity of the collapsible door 210 as a whole. The slider, as it couples the first portion 220 and the second portion 240 together, also allows for the collapsible door 210 to move as a whole between the closed position and the open position.

The collapsible door 210 is coupled to the trailer via a plurality of hinges. The first portion 220 is coupled to the trailer top portion 250 via the upper hinge 224 and the middle hinge 226 and the second portion 240 is coupled to the trailer bottom portion 260 via the bottom hinge 242. The upper hinge 224, the middle hinge 226, and the bottom hinge 242 are collectively referred to as the “hinges.” The hinges allow for the collapsible door 210 to be moved between the open position and the closed position about hinge points that are along a hinge axis. The hinge axis is the same for all of the hinges so that each portion of the collapsible door 210 swings together. The hinge axis is offset from the door jamb and the collapsible door 210 to allow for the collapsible door 210 to seal against the door jamb and to provide a larger access area into the trailer. For example, the offset can allow for the door to be sized to allow for a wheelchair to access the inner area of the trailer. One or more of the hinges can be configured to engage a slot in the corresponding trailer portion such that the hinges do not extend away from the surface of the trailer portion and inducing drag during motion. For example, the upper hinge 224 engages a slot in the trailer top portion 250 that extends from the door jamb to the hinge point. Similarly, the bottom hinge 242 engages a slot in the trailer bottom portion 260 that extends from the door jamb to the hinge point. The bottom hinge 242 can include one or more component configured to offset the hinge axis of the second portion 240 so that the hinge axis aligns with the hinge axis of the first portion 220 as discussed further below in reference to FIG. 4C. The hinges can be configured (e.g., sized, etc.) such that the forces associated with moving the trailer between the collapsed configuration and the expanded configuration are transferred to the slider without damaging (e.g., bending, deforming, etc.) the hinges. In some embodiments, and as depicted in FIG. 2B, the middle hinge 226 may be located below the bottom hinge 242 when the trailer system 200 is in the collapsed configuration. As shown, the collapsible door 210 can be opened and/or pivoted about a single hinge axis in the collapsed configuration (FIGS. 2A-2B) and in the expanded configuration (FIGS. 2C-2D).

As shown in FIGS. 2A-2D, the first portion 220 includes a window opening. In other embodiments, the first portion 220 may not include the window. In some embodiments, the first portion can include a different configuration of window (e.g., shape, size, etc.) and/or include multiple windows. In some embodiments, the second portion 240 can also include a window opening that, when in the collapsed configuration, is configured to at least partially overlap with the window opening of the first portion 220. The overlap allows a user to be able to see through the window opening in both the collapsed configuration and the expanded configuration.

The latch 222 is configured to, when activated, selectively secure the collapsible door 210 in the closed position. The latch 222 is configured to engage a corresponding portion (e.g., strike plate, faceplate, accepting portion, etc.) of the trailer top portion 250. When activated, the latch 222 extends partially into the trailer top portion 250 thus preventing the collapsible door 210 from moving from the closed position to the open position. The latch 222 can be disengaged via one or more of the handles including the outside handle 221, the lower handle 225a, and/or the upper handle 225b. The handles allow for a user to disengage the latch 222 regardless of the configuration of the trailer system 200.

The outside handle 221 is located on the outer surface of the first portion 220. The outside handle is located near the bottom of the first portion 220. The position of the outside handle 221 on the first portion 220 can allow for the outside handle 221 to be accessible (e.g., within reach) to a user in both the collapsed configuration and the expanded configuration. On the inside of the trailer system 200 (e.g., the inside of the trailer), the lower handle 225a and/or the upper handle 225b can be accessed and used to disengage the latch 222. The lower handle 225a and the upper handle 225b are located on the inner surface of the first portion 220. The lower handle 225a is near the bottom of the first portion 220 (e.g., below the window) but above the portion of the first portion 220 where the second portion 240 overlaps in the expanded configuration, as seen in FIG. 2D. The upper handle is near the top of the first portion 220 (e.g., above the window). The lower handle 225a, as seen in FIG. 2D, is accessible in the expanded configuration so that a user does not have to reach the upper handle 225b. However, as seen in FIG. 2B, the lower handle 225a may be inaccessible in the collapsed configuration, as the second portion 240 overlaps the first portion 220 to cover the lower handle 225a. Thus, in the collapsed configuration, the upper handle 225b can be used to disengage the latch 222. Including multiple handles for operating the latch 222 regardless of the configuration of the trailer system 200 allows for the collapsible door 210 to be easily operable and accessible during all points of operation.

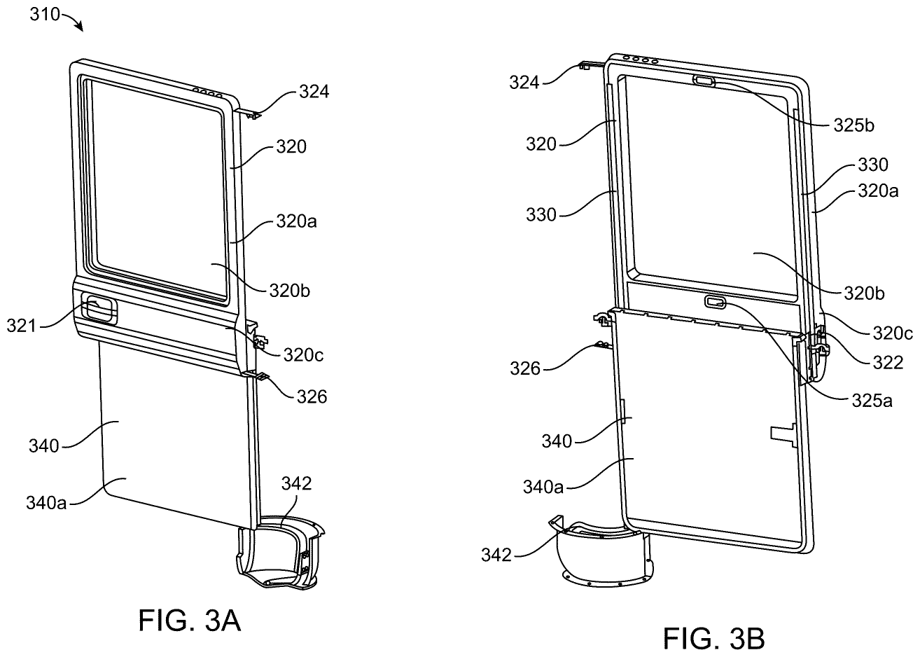

FIGS. 3A-3B depicts perspective views of a collapsible door 310, according to an embodiment. The collapsible door 310 can be functionally and/or structurally similar to the collapsible door 110 and/or 210. The collapsible door 310 includes a first portion 320, a second portion 340, and a slider 330 (e.g., functionally and/or structurally similar to the first portion 120 and/or 220, the second portion 140 and/or 240, and the slider 130). The first portion 320 includes a latch 322, an outside handle 321, an upper hinge 324, a middle hinge 326, a lower handle 325a, and an upper handle 325b (e.g., functionally and/or structurally similar to the latch 122 and/or 222, the outside handle 221, the first (or upper) hinge 124 and/or 224, the middle hinge 126 and/or 226, the lower handle 225a, and the upper handle 225b, respectively). The second portion 340 includes a bottom hinge 342 (e.g., functionally and/or structurally similar to the second (or bottom hinge 142 and/or 242).

The first portion 320 includes a body 320a (e.g., frame, structure, etc.). The body 320a of the first portion 320 defines the general structure of the first portion 320. The body 320a is a generally rectangular shape to define an upper portion of the collapsible door 310. The top corners of the body 320a are rounded. In some embodiments, the body 320a can have a different shape (e.g., semicircular, portion of an oval, etc.) based on a desired shape of the collapsible door 310. The body 320a defines a window opening 320b and a protruding portion 320c. The window opening is a rectangular opening that is defined by an opening in the body 320a. In some embodiments, the window opening can be another shape (e.g., circular, triangular, etc.). In some embodiments, the portion of the body 320a adjacent to the window opening 320b may be reinforced to provide desired stiffness.

The protruding portion 320c is a portion of the body 320a at the bottom of the first portion 320 that extends away from the plane defined by the remainder of the body 320a. The protruding portion 320c can be curved so that the body 320a is continuous and smooth. The protruding portion 320c can be configured to house the latch 322 and the outside handle 321 and protrudes to provide adequate space for components of the latch 322 and the handle outside handle 321. In some embodiments, the protruding portion 320c can correspond (e.g., be a continuation of) a protruding portion of an associated trailer top portion. The lower handle 325a and the upper handle 325b are disposed in an inner surface of the body 320a. The lower handle 325a, the upper handle 325b, and the outside handle 321 (collectively referred to as the “handles”) are operatively coupled to the latch 322. For example, the handles can be operatively coupled to the latch 322 via one or more wire that is configured to electrically and/or physically disengage the latch 322. The one or more wire can be within a cavity defined by the body 320a.

Second portion 340 includes a body 340a (e.g., frame, structure, etc.). The body 340a defines the general structure of the second portion 340. The body 340a is a generally rectangular shape to define a lower portion of the collapsible door 310. The bottom corners of the body 340a are rounded. The shape of the body 340a is associated with the shape of the body 320a so that the shapes overlap in the collapsed configuration. The body 340a is a solid body without any openings. However, in some embodiments, the body 340a can include one or more openings, similar to the second portion 240 of FIGS. 2A-2D.

The slider 330 is configured to allow for the first portion 320 and the second portion 340 to slide vertically relative to one another and to couple the portions together so that they can move together when hinging. The slider 330 includes two sets of slider and rail that are disposed along the outside vertical edges of the second portion 340 and the inner vertical edges of the first portion 320. The location of the slider 330 avoids the window opening 320b while providing the collapsible door 310 with increased stiffness by including two sliders. During operating, the first portion 320 and the second portion 340 slide along the length of the slider 330 so that a portion of the outer surface of the second portion 340 abuts a portion of the inner surface of the first portion 320 in the collapsed configuration.

The collapsible door 310 includes the upper hinge 324 and the middle hinge 326 of the first portion 320 and the bottom hinge of the second portion 340 (e.g., collectively referred to as “the hinges”). The hinges are all configured to rotate about a hinge axis so that the collapsible door 310 can be operated as a whole in both configurations. The upper hinge 324 extends horizontally away from a top corner of the body 320a. The middle hinge 326 extends horizontally away from a bottom corner of the body 320a, on the same side as the upper hinge 324. The bottom hinge 342 extends horizontally away from body 340a on the same side as the upper hinge 324 and the middle hinge 326. The hinges allow for both hinging about the hinge axis and for transferring vertical forces from the trailer to the door so that the door can be moved between the collapsed configuration and the expanded configuration.

FIGS. 4A-4C depict detailed views of the hinges of a collapsible door 410, according to embodiments. The collapsible door 410 can be functionally and/or structurally similar to the collapsible door 110, 210, and/or 310. The collapsible door 410 includes an upper hinge 424, a middle hinge 426, and a bottom hinge 442 (e.g., functionally and/or structurally similar to the first (or upper) hinge 124, 224, and/or 324, the middle hinge 126, 226, and/or 326, and the second (or bottom) hinge 142, 242, and/or 342, respectively). The collapsible door 410 includes a first portion 420 and a second portion 440 (e.g., functionally and/or structurally similar to the first portion 120, 220, and/or 320 and the second portion 140, 240, and/or 340).

FIG. 4A depicts a detailed view of the upper hinge 424. The upper hinge 424 includes a mounting bracket 424a, an offset bar 424b, a pivot 424c, and a trailer bracket 424d. The upper hinge 424 is coupled to a top corner of the body 420a of first portion 420 via the mounting bracket 424a. The mounting bracket 424a is defined by a portion of the body 420a that is configured to receive the offset bar 424b. In some embodiments, the mounting bracket 424a can be coupled to the offset bar 424b via one or more fastener such as a screw, a nut, a pin, a latch, and/or the like. In some embodiments, the mounting bracket 424a can include one or more openings that is/are larger than the associated fastener so that the offset bar 424b can be adjusted in one or more dimension. For example, the offset bar 424b can be adjusted to align the hinge axis of the upper hinge 424 with the hinge axes of the other hinges of the collapsible door 410. The mounting bracket 424a allows the offset bar 424b to be fixedly coupled to the body 420a. In some embodiments, the mounting bracket 424a and the offset bar 424b can be formed together. The offset bar 424b extends away from the edge of the body 420a to provide an offset distance between the edges of the body 420a and the hinge point. The trailer bracket 424d is configured to couple to a trailer top portion (e.g., the trailer top portion 150 of FIG. 1 and/or the trailer top portion 250 of FIGS. 2A-2D) via one or more fasteners configured to fixedly couple the trailer bracket 424d to the trailer top portion. In some embodiments, the trailer bracket 424d can be welded to or adhered to the trailer top portion. In some embodiments, the trailer bracket 424d can be a portion of the trailer top portion. The offset bar 424 b and the trailer bracket 424 d are hingedly coupled via a pivot 424c. The pivot 424c allows for the offset bar 424 b to rotate about the trailer bracket 424 d. In some embodiments, the pivot 424c can be a bearing, a pin, a hinge, and/or the like. In some embodiments, each component of the upper hinge 424 is sized to support the collapsible door 410 in the open position and to transfer forces to the first portion 420 when the collapsible door 410 is moving between the expanded configuration and the open configuration.

FIG. 4B depicts a detailed view of the middle hinge 426. The middle hinge 426 includes a mounting bracket 426a, an offset bar 426b, a pivot 426c, and a trailer bracket 426d. The middle hinge 426 is coupled to a bottom corner of the body 420a of first portion 420 via the mounting bracket 426a. The mounting bracket 426a is defined by a portion of the body 420a that is configured to receive the offset bar 426b. In some embodiments, the offset bar 426b can be coupled to the body 420a via one or more fastener such as a screw, a nut, a pin, a latch, and/or the like. In some embodiments, the mounting bracket 426a can include one or more openings that is/are larger than the associated fastener so that the offset bar 426b can be adjusted in one or more dimension. For example, the offset bar 426b can be adjusted to align the hinge axis of the middle hinge 426 with the hinge axes of the other hinges of the collapsible door 410. The mounting bracket 426a allows the offset bar 426b to be fixedly coupled to the body 420a. In some embodiments, the mounting bracket 426a and the offset bar 426b can be formed together. The offset bar 426b extends away from the edge of the body 420a to provide an offset distance between the edges of the body 420a and the hinge point. The trailer bracket 426d is configured to couple to the trailer top portion via one or more fasteners configured to fixedly couple the trailer bracket 426d to the trailer top portion. In some embodiments, the trailer bracket 426d can be welded to or adhered to the trailer top portion. In some embodiments, the trailer bracket 426d can be a portion of the trailer top portion. The offset bar 426b and the trailer bracket 426d are hingedly coupled via a pivot 426c. The pivot 426c allows for the offset bar 426b to rotate about the trailer bracket 426d. In some embodiments, the pivot 426c can be a bearing, a pin, a hinge, and/or the like. In some embodiments, each component of the middle hinge 426 is sized to support the collapsible door 410 in the open position and to transfer forces to the first portion 420 when the collapsible door 410 is moving between the expanded configuration and the open configuration.

FIG. 4C depicts a detailed view of the bottom hinge 442. The bottom hinge 442 includes a mounting bracket 442a, a first offset bar 442b, a second offset bar 442c, a pivot 442d, and a trailer bracket 442e. The bottom hinge 442 is coupled near the bottom edge of the body 440a of the second portion 440 via the mounting bracket 442a. The mounting bracket 442a is defined by a portion of the body 440a that is configured to receive the first offset bar 442b. In some embodiments, the first offset bar 442b can be coupled to the body 440a via one or more fastener such as a screw, a nut, a pin, a latch, and/or the like. In some embodiments, the mounting bracket 442a can include one or more openings that is/are larger than the associated fastener so that the first offset bar 442b can be adjusted in one or more dimension. For example, the first offset bar 442b can be adjusted to align the hinge axis of the bottom hinge 442 with the hinge axes of the other hinges of the collapsible door 410. The mounting bracket 442a allows the first offset bar 442b to be fixedly coupled to the body 440a. In some embodiments, the mounting bracket 426a and the first offset bar 442b can be formed together. Unlike the offset bar 424b and the offset bar 426b, the first offset bar 442b includes a horizontal portion that extends horizontally away from the body 440a and a vertical portion that curves down and away from the bottom of the body 440a. The horizontal portion is curved such that when the first portion 420 is coupled to the second portion 440, the hinge axes are aligned as the second portion 440 is not vertically aligned with the first portion 420. For example, the horizontal portion can curve toward the first portion 420. The vertical portion couples to the second offset bar 442c via one or more fastener. The coupling between the first offset bar 442b and the second offset bar 442c can be adjusted similar to the adjustment between the mounting bracket 442a and the first offset bar 442b to provide additional degrees of adjustment (e.g., two additional degrees of adjustment). The additional degrees of adjustment allow for further adjusting of the collapsible door's hinge axis so that the door operates as desired (e.g., stays open when in the open position, closes automatically, has aligned hinge axes, etc.). In some embodiments, the configuration of the first offset bar 442b and the second offset bar 442c allow for a portion of the weight of the collapsible door 410 to be transferred to the pivot 442d. The second offset bar 442c curves back toward the body 440a such that the second offset bar 442c can be coupled to the trailer bracket 442e in a horizontal plane, such as allowing for rotation about the pivot 442d. The pivot 442d allows for the second offset bar 442c to rotate about the trailer bracket 442e. In some embodiments, the pivot 442d can be a bearing, a pin, a hinge, and/or the like. The trailer bracket 442e is curved, which in some implementations, can protect the first offset bar 442b and the second offset bar 442c during operation. The trailer bracket 442e, when coupled to the trailer bottom portion, forms a cavity in which the bottom hinge 442 operates. In some embodiments, each component of the bottom hinge 442 is sized to support the collapsible door 410 in the open position and to transfer forces to the second portion 440 when the collapsible door 410 is moving between the expanded configuration and the open configuration.

FIGS. 5A-5B depict detailed views of a slider 530 of a collapsible door 510, according to an embodiment. The collapsible door 510 can be functionally and/or structurally similar to the collapsible door 110, 210, 310, and/or 410. The collapsible door 510 includes a first portion 520 and a second portion 540 (e.g., functionally and/or structurally similar to the first portion 120, 220, 320, 420 and the second portion 140, 240, 340, and/or 440, respectively). The slider 530 can be functionally and/or structurally similar to the slider 130. The slider 530 includes a slider bracket 532, a slider block 534, and a channel 536. The slider 530 is configured to allow for the first portion 520 and the second portion 540 to slide vertically relative to one another. In some embodiments, the collapsible door 510 can include more than one slider to provide the collapsible door 510 with additional stiffness. In some embodiments, the slider 530 does not include any moving parts to decrease the complexity of the slider 530.

The slider bracket 532 is configured to couple the slider block 534 to the second portion 540. As seen in FIG. 5A, the slider bracket 532 is coupled to a side of the second portion 540. The slider bracket 532 can be coupled to the second portion 540 via one or more fasteners (e.g., screws, bolts, pins, latches, clips, etc.). In some embodiments, the slider bracket 532 is coupled to the second portion via a glue or adhesive. In some embodiments, the slider bracket 532 can be integrally formed with the second portion 540. The slider bracket 532 is coupled to the slider block 534. The slider bracket 532 can be coupled to the slider block 534 via one or more fasteners (e.g., screws, bolts, pins, latches, clips, etc.). In some embodiments, the slider bracket 532 is coupled to the slider block 534 via a glue or adhesive. In some embodiments, the slider bracket 532 can be integrally formed with the slider block 534. The slider block 534 is a shaped component that is configured to be received by the channel 536. The slider block 534 has a T-shaped horizontal cross-section but can be formed of any shape that would be prevented from falling out of the channel 536. For example, the slider block 534 can be a dovetail shape, a trapezoid shape, etc. In some embodiments, the slider block 534 is a unitary object. In some embodiments, the slider block 534 can be formed of one or more component.

The channel 536 is coupled to the first portion 520. The channel 536 can be coupled to the first portion 520 via one or more fasteners (e.g., screws, bolts, pins, latches, clips, etc.). In some embodiments, the channel 536 is coupled to the first portion 520 via a glue or adhesive. In some embodiments, the channel 536 can integrally formed with the first portion 520. The channel 536 is a linear bushing configured to receive the slider block 534 as to allow for the slider block 534 to slide vertically along the channel 536 while preventing the slider block 534 from falling out of the channel 536, thus allowing for the collapsible door 510 to be moved between the open and the closed position as a unitary object and allows for movement between the collapsed configuration and the expanded configuration. The shape of the channel 536 is associated with the shape of the slider block and can include a cavity that is substantially the same as the shape of the slider block 534. In some embodiments, the slider block 534 and/or the channel 536 can be formed a material configured to reduce friction such as a composite. In some embodiments, the slider block 534 and/or the channel 536 can be lubricated to reduce friction. In some embodiments, the channel 536 and/or the slider block 534 can include one or more stop that is/are configured to restrict the range of motion to a desired range (e.g., to prevent the first portion 520 from uncoupling from the second portion 540).

FIGS. 6A-6B depict perspective views of a latch 622 of a collapsible door 610, according to embodiments. The latch 622 and the collapsible door 610 can be functionally and/or structurally similar to the latch 122 and/or 222 and the collapsible door 110, 210, 310, 410, and/or 510, respectively. The latch 622 is operatively coupled to an outside handle 621, a lower handle 625a, and an upper handle 625b via conduits 627. The outside handle 621, the lower handle 625a, and the upper handle 625b can be functionally and/or structurally similar the outside handle 221 and/or 321, the lower handle 225a and/or 325a, and the upper handle 225b and/or 325b, respectively.

In some embodiments, the conduits 627 can be a cable system such as a Bowden cable that allows mechanical energy to be transferred via a cable. In some embodiments, the conduits 627 can be configured to transfer signals that can transmit door opening commands. Each of the handles can include an associated conduit 627. The conduits 627 can extend through a cavity in the body of the first portion 620. The conduits 627 associated with the upper handle 625b and the lower handle 625a are operatively coupled to a splitter 670 which is configured to transfer the mechanism energy from either of the lower handle 625a and/or the upper handle 625b to a single conduit 627 operatively coupled to the latch 622. The conduit 627 from the outside handle 621 is also operatively coupled to the latch 622, thus allowing for the latch 622 to be disengage by the outside handle 621, the lower handle 625a, and/or the upper handle 625b.

In some embodiments, the latch 622 can include one or more switches. For example, the one or more switches can include a door handle limit switch configured to sense a locked position or an unlocked position and/or a reed switch configured to sense the closed position or the open position. The switches can be configured to send information to a computing system associated with the collapsible door 610.

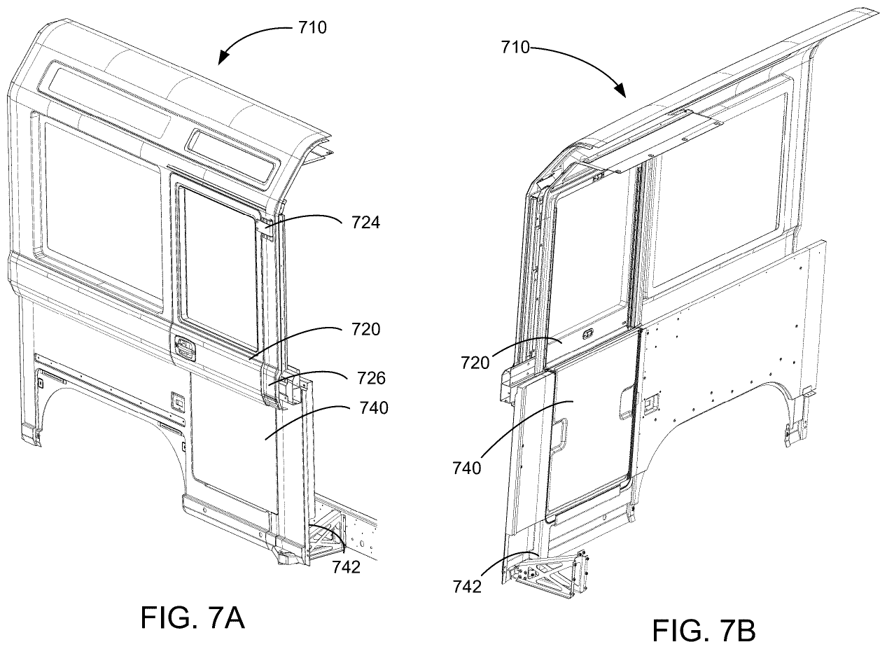

FIGS. 7A-7B depict perspective view of a collapsible door 710, according to an embodiment. The collapsible door 710 includes a first portion 720 and a second portion 740. The collapsible door 710 further includes a slider to allow one of the first portion 720 and the second portion 740 to slide relative to the other of the first portion 720 and the second portion 740. The first portion 720 can include one or more hinges (e.g., an upper hinge 724 and a middle hinge 726 similar to those described in FIGS. 1-2D) and one or more handles (e.g., an outside handle, an upper handle, and/or a lower handle similar to those described in FIGS. 1-2D). The upper hinge 724 and the middle hinge 726 couple the first portion 720 of the collapsible door 710 to the trailer body or a door frame associated with the trailer body. The upper hinge 724 and the middle hinge are configured to allow the first portion 720 to pivot about or relative to a hinge axis associated with and/or defined by the upper hinge 724 and middle hinge 726. In some embodiments, the second portion 740 can include one or more hinges (e.g., a bottom hinge 742). The collapsible door 710 can be structurally and/or functionally similar to the collapsible door 110, 210, 310, and therefore, certain details of the collapsible door 710 are not described again with respect to FIGS. 7A-7B.

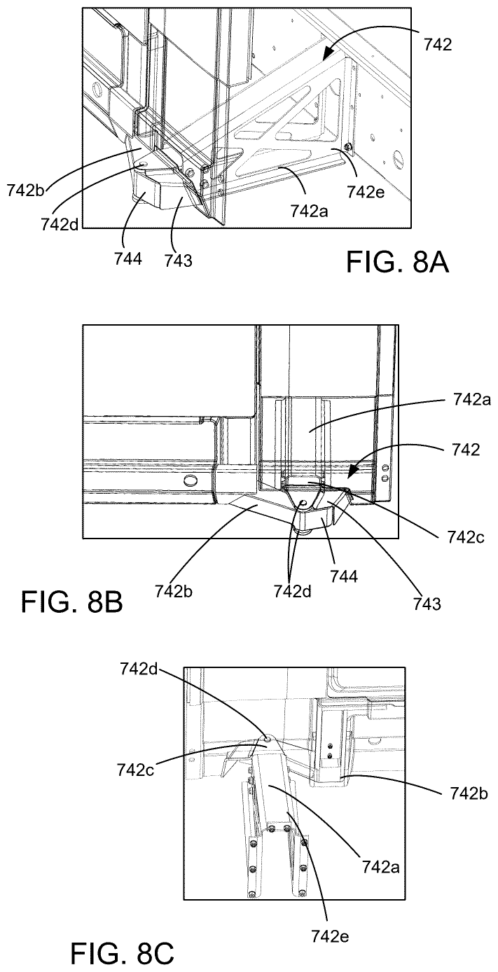

FIGS. 8A-8C show a perspective view, a front view, and a back view, respectively of the bottom hinge 742. As shown, the bottom hinge 742 can include a support member 742a (e.g., an arm, bar, extension, standoff, offset, etc.), a pivot member 742b (e.g., arm, bar, extension, offset, etc.), a pivot pin 742d (e.g., a pin, bearing, axis, coupler, etc.), and/or one or more fasteners. In some embodiments, the one or more fasteners can include screw(s), nut(s), pin(s), latch(es), coupler(s), and/or the like.

The support member 742a includes a first end portion 742c and a second end portion 742e. The second end portion 742e can include or form a flange, lip, and/or the like configured to provide a structure for mounting the support member 742a to a frame or frame component of the trailer. As shown, the support member 742a extends a horizontal distance from the frame or frame component to which it is mounted. The first end portion 742c of the support member 742a is opposite the second end portion 742e and is proximate to or near an exterior of the trailer body. The first end portion 742c includes or forms a mounting bracket configured to couple to the pivot member 742b of the bottom hinge 742 and is shaped and/or configured to allow the pivot member 742b to pivot or rotate relative thereto (e.g., about the pivot pin 742d). As such, the bottom hinge 742 defines a hinge axis that is offset from the frame or frame component of the trailer. Moreover, the hinge axis is substantially aligned or coaxial with the hinge axis defined or associated with the first portion 720 (e.g., the upper hinge 724 and the middle hinge 726).

The pivot member 742b includes a horizontal portion and a vertical portion. In some embodiments, the vertical portion can include a mounting bracket or portion (not shown) configured to couple the pivot member 742b (and therefore, the bottom hinge 742) to the second portion 740 of the collapsible door 710. The vertical portion can accommodate an offset of the collapsible door 710 (or a mounting of the collapsible door 710) from a bottom of the trailer. The horizontal portion of the pivot member 742b is coupled to the first end portion 742c (or mounting bracket thereof) of the support member 742a and is configured to pivot about the pivot pin 742d. As such, the pivot member 742b movably couples the collapsible door 710 to the bottom hinge and allows the collapsible door 710 (or at least the second portion 740 thereof) to pivot about pivot pin 742d between an open position and a closed position.

As shown in FIGS. 8A-8C, the first end portion 742c of the support member 742a defines an opening or slot configured to receive the horizontal portion of the pivot member 742b. The pivot pin 742d extends vertically through the first end portion 742c of the support member 742a and the pivot member 742b and is configured to allow the pivot member 742b to rotate about the pivot pin 742d. The arrangement of the collapsible door 710 is such that the first portion 720 (upper portion) of the collapsible door 710 is spaced outward of the second portion 740 (lower portion) of the collapsible door 710 (see e.g., FIGS. 7A and 7B). As such, bottom hinge 742 is sized, shaped, and/or configured to account for the offset based at least in part on the arrangement of the support member 742a and the pivot member 742b. Therefore, a single vertical hinge axis extends through each of the upper hinge 724, the middle hinge 726, and the bottom hinge 742, which allows the collapsible door 710 to rotate or pivot about the hinge axis when the collapsible door 710 is in both the collapsed configuration and the expanded configuration. In some embodiments, the bottom hinge 742 can include a cover (e.g., a visor, a shield, a sleeve) 743 coupled to the first end portion 742c of the support member 742a and can at least partially define a space through which a portion of the pivot member 742b can move during rotation of the pivot member 742b.

In some embodiments, the arrangement and/or configuration of the bottom hinge 742 can define or at least partially define a range of motion associated with the collapsible door 710 rotating or pivoting between the open position and the closed position. For example, as shown in FIGS. 8A and 8B an end or end region of the horizontal portion of the pivot member 742 b extends beyond the pivot pin 742d. In some embodiments, as the collapsible door 710 is moved to the open position (e.g., a fully open position), the end or end region of the pivot member 742b can rotate or pivot about the pivot pin 742d and can engage or contact, for example, the first end portion 742c of the support member 742a. The engagement or contact between the end or end region of the pivot member 742b and the first end portion 742c of the support member 742a can operate or function as a stop that stops or substantially stops further rotation or pivoting of the collapsible door 710 (e.g., in a direction away from the closed position). As such, the bottom hinge 742 can define a range of motion associated with opening the collapsible door 710 (either in the collapsed configuration or the expanded configuration) that can prevent or substantially prevent the collapsible door 710 from contacting the trailer body (which may result in damage). Furthermore, in some embodiments, the pivot member 742b can include a feature, member, component, etc. configured to at least temporarily maintain the collapsible door 710 in the open position. For example, such a feature can be a spring loaded protrusion configured to engage or be at least partially disposed in a recess (or vice versa). In other embodiments, the bottom hinge 742 can include any other suitable feature configured to at least temporarily maintain the collapsible door 710 in the open configuration (e.g., until a sufficient force is exerted on the collapsible door 710 to move the collapsible door 710 to or toward the closed position).

The specific terminology used herein is for the purpose of describing particular embodiments and/or features or components thereof and is not intended to be limiting. Throughout the entirety of the present disclosure, use of the articles “a” and/or “an” and/or “the” to modify a noun may be understood to be used for convenience and to include one, or more than one, of the modified noun, unless otherwise specifically stated. With respect to the use of singular and/or plural terms herein, those having skill in the art can translate from the singular to the plurality and/or vice versa as is appropriate for the context and/or application. Furthermore, any reference herein to a singular component, feature, aspect, etc. is not intended to imply the exclusion of more than one such component, feature, aspect, etc. (and/or vice versa) unless expressly stated otherwise.

In general, terms used herein and in the appended claims are intended as “open” terms unless expressly stated otherwise. For example, the term “including” should be interpreted as “including but not limited to,” the term “having” should be interpreted as “having at least,” etc. Similarly, the term “comprising” may specify the presence of stated features, elements, components, integers (or fractions thereof), steps, operations, and/or the like but does not preclude the presence or addition of one or more other features, elements, components, integers (or fractions thereof), steps, operations, elements, components, and/or groups thereof, and/or the like unless such combinations are otherwise mutually exclusive.

As used herein the term “and/or” includes any and all combinations of one or more of the associated listed items. It should be understood that any suitable disjunctive word and/or phrase presenting two or more alternative terms, whether in the written description or claims, contemplates the possibilities of including one of the terms, either of the terms, or both/all of the terms. For example, the phrase “A and/or B” will be understood to include the possibilities of “A” alone, “B” alone, or a combination of “A and B.”

Unless otherwise stated, the terms “about,” “approximately,” and/or “substantially” when used in connection with stated value(s) and/or geometric structure(s) or relationship(s) is intended to convey that the value or characteristic so defined is nominally the value stated, or characteristic described. For example, a first structure or feature may be described as being substantially parallel to a second structure or feature when the structures are nominally parallel. In some instances, the terms “about,” “approximately,” and/or “substantially” can generally mean and/or can generally contemplate a value or characteristic stated within a desirable tolerance (e.g., plus or minus 10% of the value or characteristic stated). While a value, structure, and/or relationship stated may be desirable, it should be understood that some variance may occur as a result of, for example, manufacturing tolerances or other practical considerations (such as, for example, applied pressures or forces, temperature variances, and/or the like). Accordingly, the terms “about,” “approximately,” and/or “substantially” can be used herein to account for such tolerances and/or considerations.

All ranges described herein include each individual member or value of the listed range, including the end members or values. Any listed ranges are intended to encompass any and all possible subranges and/or combinations of subranges thereof unless expressly stated otherwise. That the upper and lower limits can independently be included in the subranges is also encompassed within the disclosure, subject to any specifically excluded limit in the stated range. Any listed range should be recognized as sufficiently describing and enabling the same range being broken down into at least equal subparts unless expressly stated otherwise.

While various schematics, embodiments, and/or implementations have been described above, it should be understood that they have been presented by way of example only, and not limitation. Various modifications, changes, and/or variations in form and/or detail may be made without departing from the scope and/or spirit of the disclosure and/or without altering the function and/or advantages thereof unless expressly stated otherwise. Likewise, while embodiments (and/or features, components, configurations, aspects, etc. thereof) may be described above in the context of certain implementations, it should be understood that such implementations are presented by way of example only, and not limitation. Any of the embodiments (and/or features, components, configurations, aspects, etc. thereof) can be used in, and/or adapted for use in, other implementations unless expressly stated otherwise. Functionally equivalent embodiments, implementations, and/or methods, in addition to those described herein, will be apparent to those skilled in the art from the foregoing descriptions and are intended to fall within the scope and/or spirit of the disclosure.

Where schematics, embodiments, and/or implementations described above indicate certain components arranged in certain orientations, configurations, or positions, the arrangement of components may be modified. Although various embodiments have been described as having particular features, configurations, and/or combinations of components, other embodiments are possible having a combination of any features, configurations, and/or components from any of embodiments described herein, except mutually exclusive combinations. The embodiments described herein can include various combinations and/or sub-combinations of the functions, components, configurations, and/or features of the different embodiments described.

The specific configurations of the various components can also be varied. For example, the size and specific shape of the various components can be different from the embodiments shown, while still providing the functions as described herein. More specifically, the size and shape of the various components can be specifically selected for a desired or intended usage. Thus, it should be understood that the size, shape, and/or arrangement of the embodiments and/or components thereof can be adapted for a given use unless the context explicitly states otherwise.

Where methods described above indicate certain events, steps, and/or procedures occurring in certain order, the ordering of certain events, steps, and/or procedures may be modified. Additionally, certain events, steps, and/or procedures may be performed concurrently in a parallel process, when possible, as well as performed sequentially as described above. While methods have been described as having particular steps and/or combinations of steps, other methods are possible having a combination of any steps from any of methods described herein, except mutually exclusive combinations and/or unless the context clearly states otherwise.

What is claimed is:

1. An apparatus, comprising:
a first portion of a collapsible door; and
a second portion of the collapsible door slidably coupled to the first portion such that the first portion is configured to slide vertically relative to the second portion to move the collapsible door between a collapsed configuration and an expanded configuration,
wherein the first portion and the second portion collectively are configured to pivot about a single hinge axis to move the collapsible door between an open position and a closed position in both the collapsed configuration and the expanded configuration.

2. The apparatus of claim 1, wherein the first portion of the collapsible door is coupled to an upper portion of a collapsible trailer via an upper hinge, and the second portion of the collapsible door is coupled to a bottom portion of the collapsible trailer via a bottom hinge.

3. The apparatus of claim 1, wherein the first portion of the collapsible door includes a portion of an upper hinge configured to be coupled to an upper portion of a collapsible trailer, and the second portion of the collapsible door includes a portion of a bottom hinge configured to be coupled to a bottom portion of the collapsible trailer.

4. The apparatus of claim 3, wherein the bottom hinge includes a pivot member mounted to a support member of the bottom portion of the collapsible trailer.

5. The apparatus of claim 4, wherein the pivot member is coupled to the second portion of the collapsible door and is configured to pivot about a pivot point when the collapsible door moves between the open position and the closed position.

6. The apparatus of claim 1, wherein the first portion of the collapsible door includes a latch configured to selectively secure the collapsible door in the closed position, the latch including at least one switch configured to determine at least one of the open position, the closed position, a locked position of the collapsible door, or an unlocked position of the collapsible door.

7. The apparatus of claim 1, wherein the first portion of the collapsible door is coupled to the second portion of the collapsible door via a rail coupled to the first portion and a slider coupled to the second portion.

8. An apparatus, comprising:
a first portion of a collapsible door;
a second portion of the collapsible door slidably coupled to the first portion such that the first portion is configured to slide relative to the second portion to move the collapsible door between a collapsed configuration and an expanded configuration;
a first hinge coupled to the first portion; and
a second hinge coupled to the second portion, the first hinge and the second hinge collectively defining a single hinge axis, the collapsible door being rotatable about the single hinge axis between an open position and a closed position when in each of the collapsed configuration and the expanded configuration.

9. The apparatus of claim 8, wherein the first portion of the collapsible door is in an upper portion of the collapsible door, the second portion of the collapsible door is a bottom portion of the collapsible door, the first hinge is an upper hinge that is coupled to an upper portion of a collapsible trailer, and the second hinge is a bottom hinge that is coupled to a bottom portion of the collapsible trailer,
wherein the upper portion of the collapsible door is coupled to the bottom portion of the collapsible door such that the upper portion is in an outward position relative to the bottom portion.

10. The apparatus of claim 9, wherein a pivot point of the upper hinge and a pivot point of the bottom hinge are aligned such that the single hinge axis extends through each pivot point.

11. The apparatus of claim 10, wherein the bottom hinge includes a support member configured to offset the bottom hinge from a portion of a frame of the collapsible trailer in a horizontal direction,
wherein the bottom hinge being offset in the horizontal direction is operable to align the pivot point of the upper hinge and the pivot point of the bottom hinge.

12. The apparatus of claim 8, further comprising:
a handle configured to be actuated by a user to move the collapsible door between an open position and a closed position when the collapsible door is in both the collapsed configuration and the expanded configuration.

13. The apparatus of claim 8, wherein the first portion of the collapsible door is coupled to the second portion of the collapsible door via a rail coupled to the first portion and a slider coupled to the second portion.

14. An apparatus, comprising:
a first portion of a collapsible door;
a second portion of the collapsible door slidably coupled to the first portion to allow the collapsible door to be transitioned between a collapsed configuration and an expanded configuration; and
a handle coupled to the first portion and configured to be actuated to move the collapsible door about a single hinge axis between an open position and a closed position when the collapsible door is in the collapsed configuration and the expanded configuration.

15. The apparatus of claim 14, wherein the first portion includes a latch configured to selectively secure the collapsible door in the closed position.

16. The apparatus of claim 14, wherein the first portion of the collapsible door is configured to slide relative to the second portion of the collapsible door to move the collapsible door between the collapsed configuration and the expanded configuration.

17. The apparatus of claim 14, further comprising:
a first hinge coupled to the first portion and a second hinge coupled to the second portion, the first hinge and the second hinge collectively defining the single hinge axis.

18. The apparatus of claim 17, wherein the first portion of the collapsible door is in an upper portion of the collapsible door, the second portion of the collapsible door is a bottom portion of the collapsible door, the first hinge is an upper hinge that is coupled to an upper portion of a collapsible trailer, and the second hinge is a bottom hinge that is coupled to a bottom portion of the collapsible trailer,
wherein the upper portion of the collapsible door is coupled to the bottom portion of the collapsible door such that the upper portion is in an outward position relative to the bottom portion.

19. The apparatus of claim 18, wherein the bottom hinge includes a support member configured to offset the bottom hinge from a portion of a frame of the collapsible trailer in a horizontal direction,
wherein the bottom hinge being offset in the horizontal direction is operable to align the upper hinge and the bottom hinge such that the upper hinge and the bottom hinge collectively define the single hinge axis.

20. The apparatus of claim 14, wherein handle is a first handle coupled to an outer surface of the first portion of the collapsible door, the apparatus further comprising:
a second handle coupled to an inner surface of the first portion of the collapsible door, the second handle configured to be actuated to move the collapsible door between the open position and the closed position when the collapsible door is in the expanded configuration; and
a third handle coupled to the inner surface of the first portion of the collapsible door, the third handle configured to be actuated to move the collapsible door between the open position and the closed position when the collapsible door is in the collapsed configuration.
